(19) United States
(12) Patent Application Publication
(10) Pub. No.: US 2024/0375353 A1
(43) Pub. Date: Nov. 14, 2024

(54) DEFECT MITIGATION IN ADDITIVE MANUFACTURING

(71) Applicant: INTERNATIONAL BUSINESS MACHINES CORPORATION, ARMONK, NY (US)

(72) Inventors: Jeremy R. Fox, Georgetown, TX (US); Jill S. Dhillon, Jupiter, FL (US); Tushar Agrawal, West Fargo, ND (US); Sarbajit K. Rakshit, Kolkata (IN)

(21) Appl. No.: 18/313,454

(22) Filed: May 8, 2023

(51) Int. Cl. B29C 64/386; B29C 64/118; B33Y 10/00; B33Y 30/00; B33Y 50/00

(52) U.S. Cl. CPC B29C 64/386; B29C 64/118; B33Y 10/00; B33Y 30/00; B33Y 50/00

(57) ABSTRACT

Described are techniques for defect mitigation in additive manufacturing. The techniques including a system having one or more computer-readable storage media storing a sliced model file of an object to be manufactured and a machine learning model configured to predict an error in the sliced model file and generate corrective printing parameters. The system further includes a Fused Filament Fabrication (FFF) three-dimensional (3D) printer communicatively coupled to the one or more computer-readable storage media. The FFF 3D printer is configured to print the object according to the sliced model file and the corrective printing parameters.

### BACKGROUND

The present disclosure relates to additive manufacturing, and, more specifically, to automated, real-time defect mitigation in additive manufacturing.

Additive manufacturing includes manufacturing techniques such as three-dimensional (3D) printing. In 3D printing, material is deposited layer-by-layer to create a component. 3D printing can be useful in applications such as prototype manufacturing and custom manufacturing of any number of parts. Further, 3D printing can be useful in applications requiring unique, delicate, complex, and/or interior geometries that are more efficient to manufacture using 3D printing than other manufacturing techniques.

During 3D printing, defects can form. One common defect is caused by part deformation. One or more layers can become deformed due to, for example, material temperatures, changes in material temperatures (e.g., due to conductive, convective, and/or radiative heat transfer), humidity, changes in humidity, part geometry (e.g., thicknesses, variations in thickness, unsupported geometries, etc.), material characteristics (e.g., viscosity, rheology, etc.), and/or other factors. The deformed layers can contribute to higher scrap rates, decreased reliability, decreased performance, and/or inadequate aesthetic characteristics.

### SUMMARY

Aspects of the present disclosure are directed toward a method including manufacturing an object using a fused filament fabrication (FFF) three-dimensional (3D) printer reading a sliced model file. The method further includes determining an error for at least one layer in the object during the manufacturing. The method further includes pausing manufacturing the object using the FFF 3D printer reading the sliced model file. The method further includes depositing additional material using the FFF 3D printer and based on corrective printing parameters generated to mitigate the error. The method further includes resuming manufacturing the object using the FFF 3D printer reading the sliced model file.

Advantageously, the aforementioned method enables defect mitigation in a 3D printed object during the manufacturing of the object, thereby reducing the need for post-processing the of the 3D printed object. Additionally, these aspects of the present disclosure can be implemented by a FFF 3D printer having a single print head, as a result, these aspects of the present disclosure are readily retrofitted into existing 3D printers.

Additional aspects of the present disclosure are directed toward a method including manufacturing an object using a primary print head of a fused filament fabrication (FFF) three-dimensional (3D) printer reading a sliced model file. The method further includes determining an error for at least one layer in the object during the manufacturing. The method further includes depositing additional material using a secondary print head of the FFF 3D printer and based on corrective printing parameters generated to mitigate the error.

Advantageously, the aforementioned method enables defect mitigation in a 3D printed object using a secondary print head. As a result, these aspects of the present disclosure can realize time-savings for defect mitigation relative to solutions relying on a single print head. For example, in some embodiments, the secondary print head can deposit additional material contemporaneously with the primary print head as it continued to fabricate the 3D printed object. In other embodiments, the secondary print head can perform other processing (e.g., selective heating, selective cooling, etc.) that are otherwise not performable by the primary print head.

Additional aspects of the present disclosure are directed toward a method including manufacturing an object using a fused filament fabrication (FFF) three-dimensional (3D) printer reading a sliced model file. The method further includes determining an error for at least one layer in the object during the manufacturing. The method further includes updating the sliced model file to correct the error in one or more subsequent layers in the object. The method further includes resuming manufacturing the object using the FFF 3D printer reading the updated sliced model file, where the updated sliced model file corrects the error in one or more subsequent layers in the object.

Advantageously, the aforementioned method enables defect mitigation by modifying a sliced model file. As a result, aspects of the present disclosure can reduce defect mitigation time by incorporating the corrective measures into the sliced model file and making the corrective measures another feature to be printed according to the updated sliced model file. In this way, an error in a 3D printed object can be permanently corrected for future fabrications of the 3D printed object, such as in a manufacturing facility.

Additional aspects of the present disclosure are directed to systems and computer program products configured to perform the methods described above.

Additional aspects of the present disclosure are directed toward a system including one or more computer-readable storage media storing a sliced model file of an object to be manufactured and a machine learning model configured to predict an error in the sliced model file and generate corrective printing parameters. The system further includes a Fused Filament Fabrication (FFF) three-dimensional (3D) printer communicatively coupled to the one or more computer-readable storage media, where the FFF 3D printer is configured to print the object according to the sliced model file and the corrective printing parameters.

Advantageously, the aforementioned system enables defect mitigation by predicting errors using a machine learning model. The machine learning model can exhibit relatively high accuracy and fast predictions. Additionally, the machine learning model can automatically generate corrective printing parameters and provide the generated corrective printing parameters to the FFF 3D printer.

Additional aspects of the present disclosure are directed toward a system including one or more computer-readable storage media storing a sliced model file of an object to be manufacture and a machine learning model configured to detect an error from observed dimensional data during manufacture of the object and generate corrective printing parameters to remedy the error. The system further includes a visual inspection tool communicatively coupled to the one or more computer-readable storage media configured to generate the observed dimensional data of the object during the manufacture. The system further includes a Fused Filament Fabrication (FFF) three-dimensional (3D) printer communicatively coupled to the one or more computer-readable storage media, where the FFF 3D printer is configured to print the object according to the sliced model file and the corrective printing parameters.

Advantageously, the aforementioned system enables defect mitigation by detecting an error using a visual inspect tool and generating corrective printing parameters using a machine learning model. As a result, these aspects of the present disclosure can detect errors in real-time (e.g., using the visual inspection tool), generate corrections (e.g., using the machine learning model) and apply the corrections (e.g., using the FFF 3D printer) before a part has otherwise finished printing.

The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example Fused Filament Fabrication (FFF) three-dimensional (3D) printer capable of real-time defect mitigation, in accordance with some embodiments of the present disclosure.

FIG. 2 illustrates a block diagram of example cross-sections exhibiting layer deformation and correction of the layer deformation using real-time defect mitigation, in accordance with some embodiments of the present disclosure.

FIG. 3 illustrates a flowchart of an example method for defect mitigation in 3D printing, in accordance with some embodiments of the present disclosure.

FIG. 4 illustrates a flowchart of an example method for defect mitigation in 3D printing using a secondary print head, in accordance with some embodiments of the present disclosure.

FIG. 5 illustrates a flowchart of an example method for defect mitigation in 3D printing using an updated sliced model file, in accordance with some embodiments of the present disclosure.

FIG. 6 illustrates a flowchart of an example method for training a machine learning model for predicting errors and/or generating corrective printing parameters in 3D printing, in accordance with some embodiments of the present disclosure.

FIG. 7 illustrates a flowchart of an example method for downloading, deploying, metering, and billing usage of additive manufacturing defect mitigation code, in accordance with some embodiments of the present disclosure.

FIG. 8 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward additive manufacturing, and, more specifically, to automated, real-time defect mitigation in additive manufacturing. While not limited to such applications, embodiments of the present disclosure may be better understood in light of the aforementioned context.

Additive manufacturing (such as as three-dimensional (3D) printing) typically involves receiving a computer-aided design (CAD) model, slicing the CAD model into numerous layers, and then printing each layer sequentially to physically manufacture a component based on the CAD model. The printing can function by any number of techniques and processes that are configured to fuse, join, or otherwise combine material. For example, 3D printing can be performed by fused-filament fabrication (FFF), vat photopolymerization, stereolithography (SLA), material jetting, binder jetting, powder bed fusion, material extrusion, directed energy deposition, sheet lamination, and/or other 3D printing techniques.

A variety of materials can be used in manufacturing. These materials can include thermoplastics that are heated to a flowing point, deposited according to the layer-by-layer deposition protocol, and allowed to cool to solidify and bind with any adjacent material. In some situations, multiple materials are used, or similar materials are used with different modifiers, reinforcements, and/or fillers for color, strength, magnetism, and/or other customized aesthetic or structural properties.

3D printers may utilize a nozzle affixed to a print head to deposit material to fabricate components. Nozzles can be engineered to balance versatility (e.g., the ability to print with a variety of materials) with performance (e.g., the ability to print high-resolution parts). For example, a relatively larger nozzle orifice can deposit more material in a single pass, thus increasing the speed at which a component can be printed. However, the larger the nozzle orifice, the less detailed the printed component (i.e., component resolution). Such tradeoffs can lead to inefficiencies in printing speed and/or limitations in printing quality.

Furthermore, material characteristics (and variability between batches of a same material), part geometry, and/or environmental conditions can lead to defects while printing. Such defects can manifest as, for example, deformations. As described above, one or more layers can become deformed due to, for example, material temperatures, changes in material temperatures (e.g., due to conductive, convective, and/or radiative heat transfer), humidity, changes in humidity, part geometry (e.g., thicknesses, variations in thickness, unsupported geometries, etc.), material characteristics (e.g., viscosity, rheology, etc.), and/or other factors. The deformed layers can contribute to higher scrap rates, decreased reliability, decreased performance, and/or inadequate aesthetic characteristics. Accordingly, there is a need for effective, real-time deformation mitigation in 3D printing.

Aspects of the present disclosure are directed toward real-time deformation mitigation in 3D printing. In some embodiments, aspects of the present disclosure analyze 3D printer parameters (e.g., nozzle parameters, such as nozzle backpressure and material temperature; environmental parameters, such as ambient temperature and ambient humidity; material properties related to viscosity; and/or other rheological properties, etc.) to calculate a score indicative of a likelihood of an upcoming anomaly (e.g., deformation) in a subsequent printed layer. In response to calculating a score above a threshold indicating a likely anomaly, aspects of the present disclosure can autocorrect the anomaly by performing additional printing before, during, and/or after the layer containing the predicted anomaly. In some embodiments, the additional printing creates an uneven layer before, during, and/or after the layer containing the predicted anomaly so that, after depositing both the anomalous layer and the corrective layer, the 3D printed part does not contain any anomaly.

In some embodiments, aspects of the present disclosure utilize a secondary print head in conjunction with the additional printing to mitigate the predicted anomaly. In some embodiments, the secondary print head deposits material for the additional printing. In some embodiments, the secondary print head performs other fabrication processes such as modifying temperatures (e.g., directed heating), accelerating material cooling (e.g., using convective cooling via compressed air), and the like.

Additionally, in some embodiments, aspects of the present disclosure create a knowledge corpus of data related to the predicted anomaly and mitigative actions. Machine learning can be applied to the knowledge corpus to improve prediction of future anomalies during 3D printing. Additionally, the machine learning can be applied to the knowledge corpus to improve error-correction.

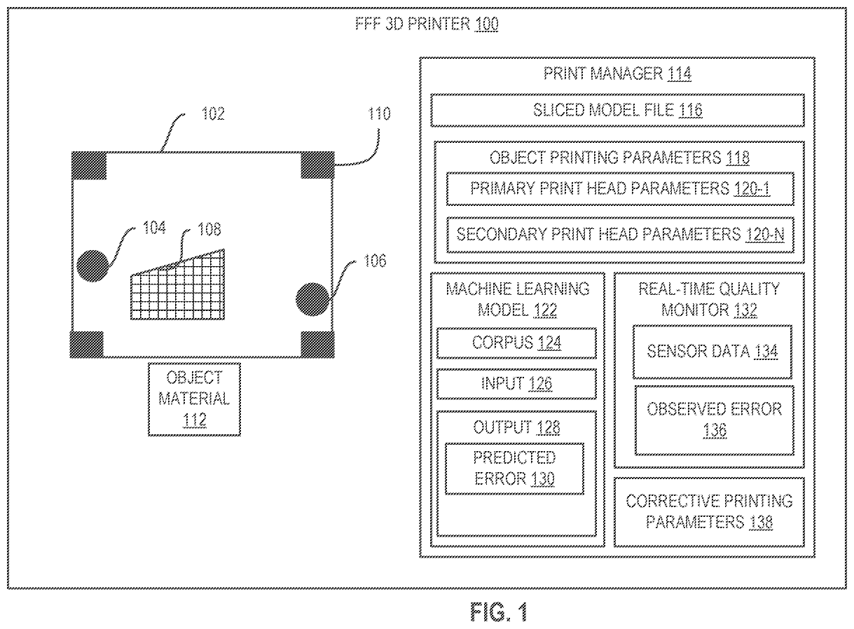

Referring now to the figures, FIG. 1 illustrates a block diagram of an example Fused Filament Fabrication (FFF) three-dimensional (3D) printer 100 capable of real-time defect mitigation, in accordance with some embodiments of the present disclosure. FFF 3D printer 100 includes a platform 102 upon which an object 108 is created using layer-by-layer deposition of object material 112 from a print head 104. The print head 104 can be configured to deposit object material 112 at a predetermined feed rate using a nozzle (e.g., with a unique orifice geometry, internal geometry, and/or external geometry) with one or more predetermined backpressures and one or more predetermined temperatures. The print head 104 can articulate in three dimensions using, for example, a ball-and-socket joint, where the print head 104 is attached by an extendable and retractable arm and may move about platform 102 in all three dimensions. In another example, the print head 104 can move in three dimensions using a track system along which, for example, the track moves forward and backward in the y-direction, the print head 104 traverses the track in the x-direction, and the track extends and retracts in the z-direction. These are only examples of print head 104, and print head 104 can include any print head architecture and articulating apparatus now known or later developed.

3D printer 100 can further include a secondary print head 106, which can be structurally and/or functionally similar or identical to print head 104. Secondary print head 106 can be configured to correct, by additive manufacturing (e.g., depositing additional material) or other processing (e.g., accelerating cooling using compressed air, increasing pliability using directed heat, etc.), one or more observed errors 136 and/or predicted errors 130 in object 108. In some embodiments, secondary print head 106 can perform corrective processing concurrently with the print head 104 printing a part of the object 108. In other embodiments, secondary print head 106 can perform corrective processing while the print head 104 is otherwise paused from printing the object 108. It should be noted that embodiments exist without the secondary print head 106, and in such embodiments, the print head 104 is configured to correct the one or more observed errors 136 and/or predicted errors 130 in object 108.

Object material 112 can include any type of material suitable for additive manufacturing. Some non-limiting examples can include: acrylonitrile butadiene styrene (ABS), thermoplastic elastomers (TPEs), thermoplastic urethanes (TPUs), poly-lactic acid (PLA), polystyrene (PS), high-impact polystyrene (HIPS), polyethylene (PE), polyethylene terephthalate (PET), polyethylene terephthalate glycol-modified (PETG), polypropylene (PP), nylon, acrylonitrile styrene acrylate (ASA), polycarbonate (PC), polyvinyl alcohol (PVA), and others. In some embodiments, object material 112 can include a combination of two or more materials (e.g., a composite, a polymer blend, etc.). Although not explicitly shown, the object material 112 can include any number of additives useful for improving processability, improving longevity, and/or improving mechanical, electrical, or temperature properties. For example, the object material 112 can comprise plasticizers, nucleating agents, desiccants, impact modifiers, chain extenders, stabilizers, carboxyl scavengers, fillers (e.g., mineral, wood, metal, aramid, carbon, graphite, etc.), and the like. In some embodiments, object material 112 can comprise reinforcement (e.g., short-fiber reinforcement, long-fiber reinforcement, continuous fiber reinforcement, etc.). Reinforcements can include, for example, carbon fiber, aramid fiber, and/or other types of natural or artificial fibers, now known or later developed.

FFF 3D printer 100 further includes sensors 110 proximate to the platform 102 for monitoring fabrication of the object 108. The sensors 110 can be, for example, cameras collecting optical data, lasers collecting distance data (which can be used to generate a 3D representation of the object 108 as it is being printed), and/or other sensors. Although four sensors 110 are shown in corners of platform 102, more or fewer sensors 110 in similar or different locations fall within the spirit and scope of the present disclosure. Sensors 110 can be useful for detecting an error (or an indication of a future error) in the object 108 in real-time during the fabrication of the object 108 by the FFF 3D printer 100.

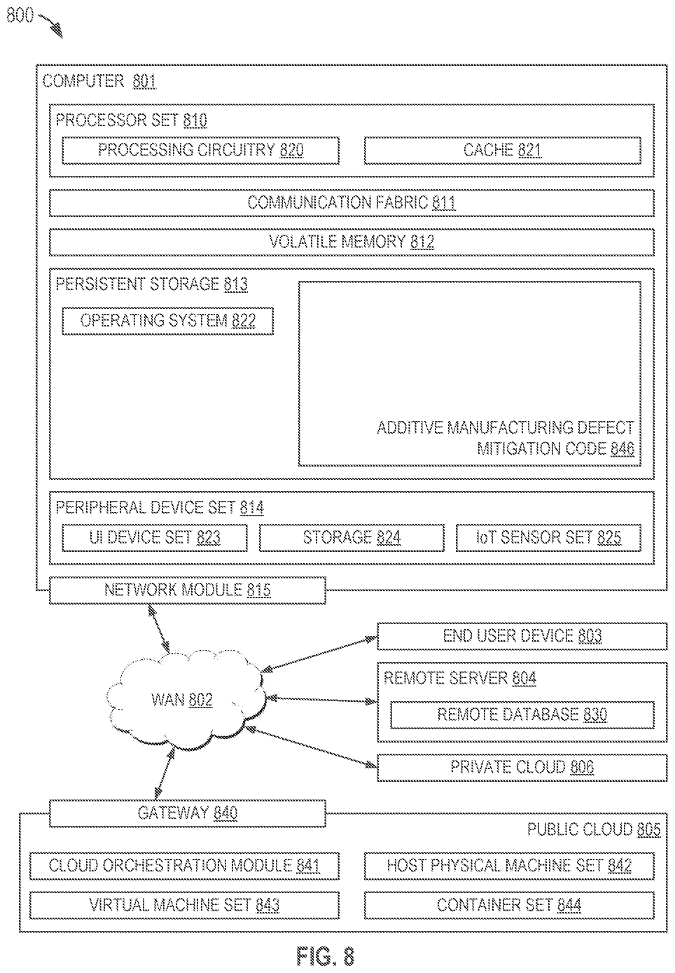

3D printer 100 further includes print manager 114. Print manager 114 is a combination of hardware and software configured to control print head 104 (and optionally, secondary print head 106) to print object 108. In some embodiments, print manager 114 utilizes sensor data 134 from sensors 110 and/or output 128 from a machine learning model 122 to provide real-time corrective printing parameters 138 while the object 108 is being printed. Print manager 114 can be implemented as code executing on hardware (e.g., additive manufacturing defect mitigation code 846 described hereafter with respect to FIG. 8).

Print manager 114 can include a sliced model file 116, object printing parameters 118, machine learning model 122, and real-time quality monitor 132. Sliced model file 116 can be, for example, a CAD model of the object 108 that is stored in, for example, a stereolithography (STL) file format and sliced into discrete layers by slicer software for layer-by-layer deposition. Sliced model file 116 can include information related to dimensions, tolerances, features, materials, and the like associated with object 108.

Print manager 114 further includes object printing parameters 118, which can relate to parameters for printing object 108. Object printing parameters 118 can include print head information and material information useful for performing printing. For example, print head information can include, but is not limited to, print head path, print head speed, nozzle feed rate, nozzle back pressure, nozzle temperature, and/or nozzle orifice size and/or geometry.

Material information can include, but is not limited to, material properties for one or more object materials 112 such as: a material type, a material melting point, a material glass transition temperature, a rheological profile of the material (e.g., viscosity, viscosity as a function of shear rate, etc.), a material elasticity profile as a function of temperature, and the like. A material melting point can be useful for defining nozzle temperature. A rheological profile of the material can be useful for defining nozzle feed rate, nozzle back pressure, and/or nozzle orifice size and/or geometry.

Object printing parameters 118 may further include specific parameters assigned to specific print heads such as primary print head parameters 120-1 and secondary print head parameters 120-N (where N is any integer representing any number of print heads used to print the object 108). Primary print head parameters 120-1 can refer to printing parameters for print head 104 and secondary print head parameters 120-N can refer to printing parameters for secondary print head 106 during printing of the object 108. Print head parameters 120 can define which portions of object 108 will be printed by each of multiple print heads (e.g., print head 104 and secondary print head 106). For example, print head 104 can be assigned to print the sliced model file 116 in primary print head parameters 120-1 and the secondary print head 106 can be assigned to print the corrective printing parameters 138 in the secondary print head parameters 120-N.

Print manager 114 further includes machine learning model 122. Machine learning model 122 can be trained on a corpus 124 of data related to printed objects and their associated defects. Machine learning model 122 can comprise algorithms or models that are generated by performing supervised, unsupervised, or semi-supervised training on a dataset, and subsequently applying the generated algorithm or model to generate one or more predicted errors 130 in object 108 prior to and/or during fabrication of the object 108. Machine learning model 122 can be further configured to generate corrective printing parameters 138 to mitigate the predicted errors 130.

Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Machine learning model 122 can be trained using corpus 124. The machine learning model 122 can then receive input 126. Input 126 can be, for example, sliced model file 116, information related to print head 104, information related to object material 112, and/or environmental information (e.g., ambient temperature, ambient humidity, etc.). The machine learning model 122 can generate output 128 in response to receiving the input 126. The output 128 can comprise, for example, a predicted error 130 and/or corrective printing parameters 138 configured to correct the predicted error 130 using the print head 104 and/or the secondary print head 106. Thus, output 128 can be used to mitigate an observed or predicted error in object 108 during printing.

Print manager 114 can further include real-time quality monitor 132 including sensor data 134 and an observed error 136. In some embodiments, real-time quality monitor 132 together with sensors 110 can be referred to as a visual inspection tool. Real-time quality monitor 132 can be configured to measure accuracy of the object 108 as it is printed relative to the specifications of the object (e.g., as stored in the sliced model file 116). Sensor data 134 can be received from one or more sensors 110 and can be used to compare a progress of printing the object 108 to the sliced model file 116 for determining if there are any observed errors 136 in the printed object 108 (e.g., out-of-tolerance features, degraded/mis-printed features, and/or other errors in the printed object 108, whether fully or partially printed). The sensor data 134 and the observed error 136 can then be used to generate corrective printing parameters 138 (e.g., by providing the sensor data 134 and/or observed error 136 to the machine learning model 122 as input 126). Corrective printing parameters 138 can add material and/or perform other corrective processing (e.g., altering temperature) to mitigate the error using the print head 104 and/or the secondary print head 106.

In some embodiments, the corrective printing parameters 138 are implemented by the print head 104. In these embodiments, the print head 104 can pause reading the sliced model file 116, apply the corrective printing parameters 138, and then resume reading the sliced model file 116 to complete printing of the object 108. In other embodiments, the corrective printing parameters 138 can be incorporated into the sliced model file 116 to create an updated sliced model file, and the print head 104 can print the object 108 using the updated sliced model file 116 incorporating the corrective printing parameters 138. In yet other embodiments, the secondary print head 106 implements the corrective printing parameters 138. In these embodiments, the secondary print head 106 can implement the corrective printing parameters 138 at the same time as the print head 104 continues to print the object 108. In other embodiments, the secondary print head 106 can implement the corrective printing parameters 138 while the print head 104 is otherwise paused from printing the object 108 according to the sliced model file 116. In yet other embodiments, the print head 104 pauses printing the object 108 according to the sliced model file 116 and both the print head 104 and the secondary print head 106 implement the corrective printing parameters 138.

The configuration illustrated in FIG. 1 is an example configuration, and it should not be construed as limiting. For example, although FIG. 1 illustrates print manager 114 incorporated into the FFF 3D printer 100, in other embodiments, the print manager 114 (or a portion of print manager 114) can be communicatively coupled to the FFF 3D printer 100 via a network. In such embodiments, features of the invention can be delivered to the FFF 3D printer 100 as a service. Further, although FFF 3D printer 100 is shown having two print heads (e.g., print head 104 and secondary print head 106), in other embodiments, a single print head can be used or more than two print heads can be used. Further, in some embodiments, either real-time quality monitor 132 is used with sensors 110 for detecting errors as they occur or machine learning model 122 is used to predict errors before they occur. In other embodiments, both machine learning model 122 and real-time quality monitor 132 with sensors 110 can be used to mitigate errors (whether predicted or observed).

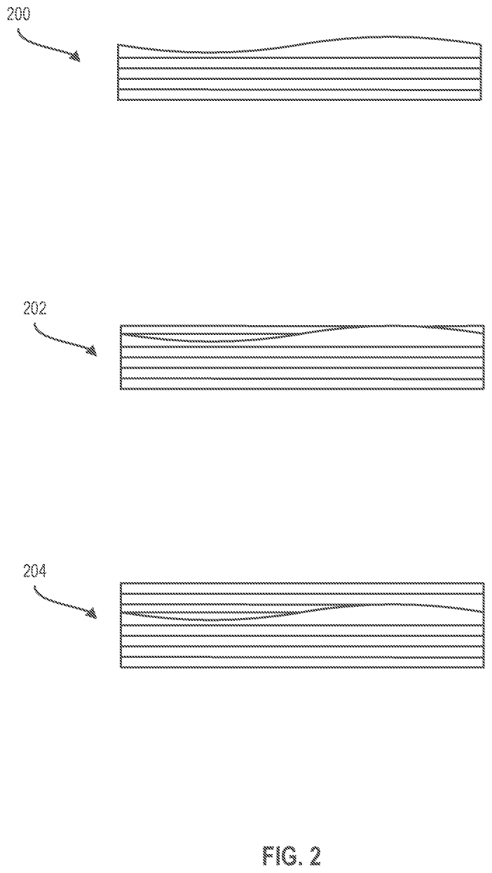

FIG. 2 illustrates a block diagram of example cross-sections exhibiting layer deformation and correction of the layer deformation using real-time defect mitigation, in accordance with some embodiments of the present disclosure. Cross-section 200 exhibits a surface that is deformed (e.g., non-linear) in a printed object. As shown in cross-section 200, the uppermost layer exhibits unintended variations in thickness. In other words, cross-section 200 exhibits an error.

Cross-section 202 exhibits application of corrective printing parameters by selectively adding additional material to render the deformed (e.g., non-linear) portion of the printed object corrected (e.g., linear). As shown in cross-section 202 multiple discrete layers with variational thickness are applied along a portion of the width of the object in order to render the deformed portion of the printed object corrected. Although not shown, in other embodiments, additional and/or alternative processing techniques can also be applied to reduce and/or correct a deformed portion of the print object. For example, selectively heating a relatively thicker portion of a deformed layer can advantageously cause distribution of the relatively thicker portion of the deformed layer by decreasing material viscosity in the relatively thicker portion.

Cross-section 204 exhibits an example output of the printed object having a corrected (e.g., linear) profile by selectively adding material to the deformed (e.g., non-linear) portions, in accordance with embodiments of the present disclosure. As shown in cross-section 204, multiple layers can be applied on top of the deformed layer(s) and corrective layer(s) to complete printing of the object. Advantageously, the deformed layer shown in cross-section 204 does not extend to remaining layers upon printing of the object. Instead, the corrective layers deposited as shown in cross-section 202 mitigate the error (and/or allow for successful rework of the error after printing is complete), and the remaining printing can occur to complete printing of the object.

As will be apparent to one of skill in the art, FIG. 2 is illustrative, and in other embodiments, cross-sections of different geometries and/or complexities are possible. Additionally, although the nature of the cross-sections shown in FIG. 2 exhibit two-dimensional deformities, aspects of the present disclosure are equally capable of correcting deformities in three dimensions.

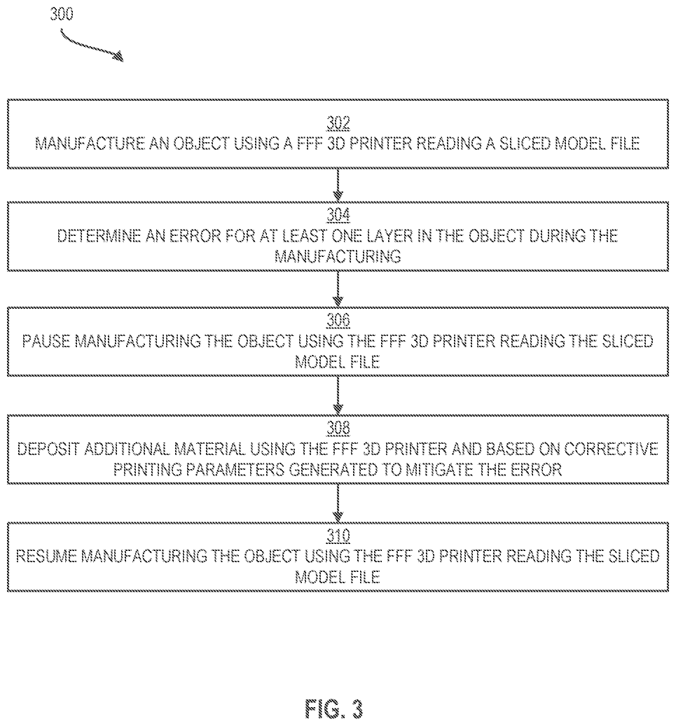

FIG. 3 illustrates a flowchart of an example method 300 for defect mitigation in 3D printing, in accordance with some embodiments of the present disclosure. The method 300 can be implemented by, for example a print manager of a 3D printer (e.g., print manager 114 of FFF 3D printer 100 as in FIG. 1), a computer implementing code (e.g., computer 801 implementing additive manufacturing defect mitigation code 846 of FIG. 8), a processor, or another configuration of hardware and/or software.

Operation 302 includes manufacturing an object using a FFF 3D printer reading a sliced model file. In various embodiments, the object can be manufactured using one print head (e.g., a primary print head) or multiple print heads (e.g., a primary print head and at least a secondary print head).

Operation 304 includes determining an error for at least one layer in the object during the manufacturing. In some embodiments, the error is identified by a visual inspection tool after depositing at least one layer in the object undergoing fabrication. In some embodiments, the error is predicted by a machine learning model, such as machine learning model 122, prior to depositing any layers in the object undergoing fabrication. In some embodiments, the error is predicted by a machine learning model while fabricating the object undergoing fabrication based on data from a visual inspection tool regarding the partially fabricated object. In embodiments utilizing a machine learning model, the error can be predicted by the machine learning model based on a geometry of the object, a material of the object, a nozzle temperature, a nozzle backpressure, a nozzle speed, an ambient temperature, and/or an ambient humidity, among other factors.

Operation 306 includes pausing manufacturing the object using the FFF 3D printer reading the sliced model file. Operation 308 includes depositing additional material using the FFF 3D printer and based on corrective printing parameters generated to mitigate the error. In some embodiments, manufacturing the object utilizes a primary print head of the FFF 3D printer (e.g., in operation 302), and depositing the additional material utilizes a secondary print head of the FFF 3D printer (e.g., in operation 308). In some embodiments, operation 308 includes other processing steps in addition to, or instead of, depositing additional material. For example, operation 308 can include selectively cooling (e.g., via compressed air), selectively heating (e.g., via a heater), and/or other processing steps configured to correct an error.

Operation 310 includes resuming manufacturing the object using the FFF 3D printer reading the sliced model file. In embodiments utilizing multiple nozzles, operation 310 can resume manufacturing using a primary print head, a secondary print head, or multiple print heads.

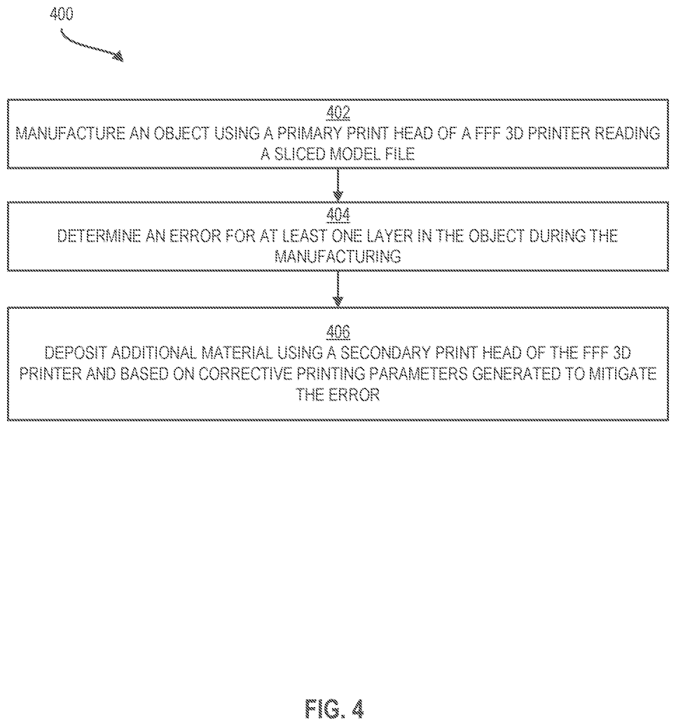

FIG. 4 illustrates a flowchart of an example method 400 for defect mitigation in 3D printing using a secondary print head, in accordance with some embodiments of the present disclosure. The method 400 can be implemented by, for example a print manager of a 3D printer (e.g., print manager 114 of FFF 3D printer 100 as in FIG. 1), a computer implementing code (e.g., computer 801 implementing additive manufacturing defect mitigation code 846 of FIG. 8), a processor, or another configuration of hardware and/or software.

Operation 402 includes manufacturing an object using at least a primary print head of a FFF 3D printer reading a sliced model file. In some embodiments, operation 402 can include printing the object using multiple print heads.

Operation 404 includes determining an error for at least one layer in the object during the manufacturing. In some embodiments, the error is identified by a visual inspection tool after depositing at least one layer in the object undergoing fabrication. In some embodiments, the error is predicted by a machine learning model prior to depositing any layers in the object undergoing fabrication. In some embodiments, the error is predicted by a machine learning model while fabricating the object undergoing fabrication based on data from a visual inspection tool regarding the partially fabricated object. In embodiments utilizing a machine learning model, the error can be predicted by the machine learning model based on a geometry of the object, a material of the object, a nozzle temperature, a nozzle backpressure, a nozzle speed, an ambient temperature, and/or an ambient humidity, among other factors.

Operation 406 includes depositing additional material using a secondary print head of the FFF 3D printer and based on corrective printing parameters generated to mitigate the error. In some embodiments, the secondary print head is configured exclusively for implementing corrective printing parameters. In other embodiments, the secondary print head is one of multiple print heads used in printing an object.

In some embodiments, operation 406 includes other processing steps in addition to, or instead of, depositing additional material. For example, operation 406 can include selectively cooling (e.g., via compressed air), selectively heating (e.g., via a heater), and/or other processing steps configured to correct an error. After performing operation 406, the method 400 can complete manufacturing of the object.

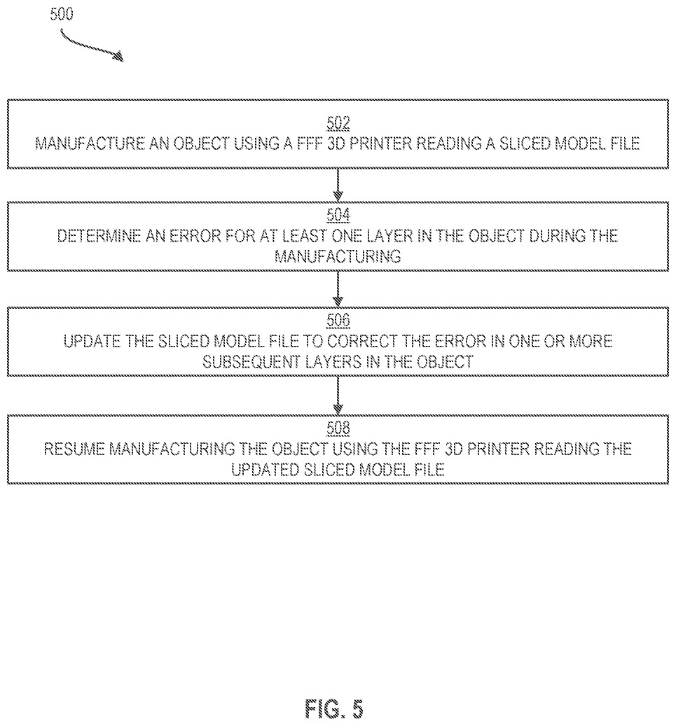

FIG. 5 illustrates a flowchart of an example method 500 for defect mitigation in 3D printing using an updated sliced model file, in accordance with some embodiments of the present disclosure. The method 500 can be implemented by, for example a print manager of a 3D printer (e.g., print manager 114 of FFF 3D printer 100 as in FIG. 1), a computer implementing code (e.g., computer 801 implementing additive manufacturing defect mitigation code 846 of FIG. 8), a processor, or another configuration of hardware and/or software.

Operation 502 includes manufacturing an object using a FFF 3D printer reading a sliced model file. In various embodiments, the object can be manufactured using one print head (e.g., a primary print head) or multiple print heads (e.g., a primary print head and at least a secondary print head).

Operation 504 includes determining an error for at least one layer in the object during the manufacturing. In some embodiments, the error is identified by a visual inspection tool after depositing at least one layer in the object undergoing fabrication. In some embodiments, the error is predicted by a machine learning model prior to depositing any layers in the object undergoing fabrication. In some embodiments, the error is predicted by a machine learning model while fabricating the object undergoing fabrication based on data from a visual inspection tool regarding the partially fabricated object. In embodiments utilizing a machine learning model, the error can be predicted by the machine learning model based on a geometry of the object, a material of the object, a nozzle temperature, a nozzle backpressure, a nozzle speed, an ambient temperature, and/or an ambient humidity, among other factors.

Operation 506 includes updating the sliced model file to correct the error in one or more subsequent layers in the object. In some embodiments, operation 506 includes adding one or more layers and/or partial layers for printing, altering one or more existing layers for printing, and/or removing one or more layers and/or partial layers for printing in the sliced model file.

Operation 508 includes resuming manufacturing the object using the FFF 3D printer reading the updated sliced model file. In various embodiments, the object can be manufactured using one print head (e.g., a primary print head) or multiple print heads (e.g., a primary print head and at least a secondary print head).

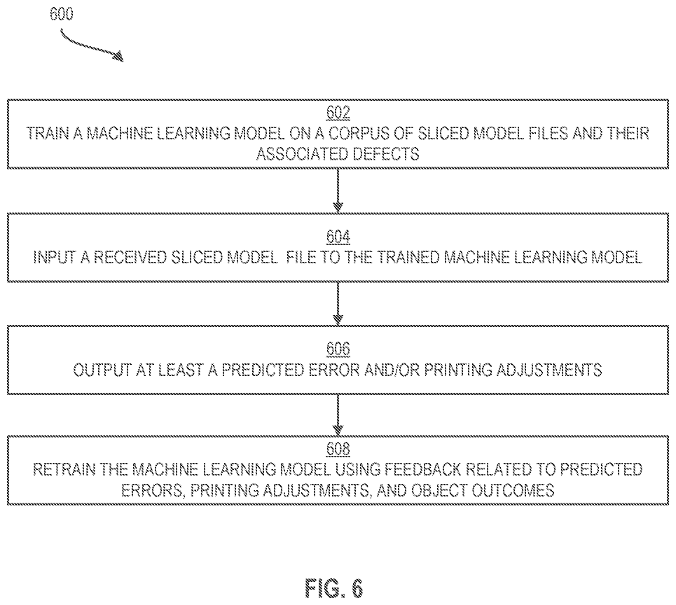

FIG. 6 illustrates a flowchart of an example method 600 for training a machine learning model for defect mitigation in 3D printing, in accordance with some embodiments of the present disclosure. The method 600 can be implemented by, for example a print manager of a 3D printer (e.g., print manager 114 of FFF 3D printer 100 as in FIG. 1), a computer implementing code (e.g., computer 801 implementing additive manufacturing defect mitigation code 846 of FIG. 8), a processor, or another configuration of hardware and/or software.

Operation 602 includes training a machine learning model on a corpus of sliced model files and their associated defects. Operation 602 can utilize any of the machine learning algorithms previously discussed with respect to the machine learning model 122 of FIG. 1.

Operation 604 includes inputting a received sliced model file to the trained machine learning model. Operation 606 includes outputting at least a predicted error and/or corrective printing parameters. In some embodiments, operation 606 outputs an updated sliced model file that includes the corrective printing parameters incorporated therein. In some embodiments, operation 606 outputs a predicted error that can be converted into corrective printing parameters using predefined algorithms. In some embodiments, operation 606 outputs the corrective printing parameters as a discrete corrective sliced model file that can be printed on the partially printed object to correct the printing defect(s).

Operation 608 includes retraining the machine learning model using feedback related to predicted errors, corrective printing parameters, and/or object outcomes. In some embodiments, the feedback can be user defined feedback indicating a user satisfaction with the predicted errors, corrective printing parameters, and/or object outcomes. In some embodiments, the feedback can be based on dimensional data collected from a visual inspection tool to identify whether or not the corrective printing parameters did, in fact, correct the printing defect(s). Although not explicitly shown, operation 608 can further include outputting the retrained machine learning model, receiving input to the retrained machine learning model, and generating output from the retrained machine learning model as previously described with respect to the original machine learning model.

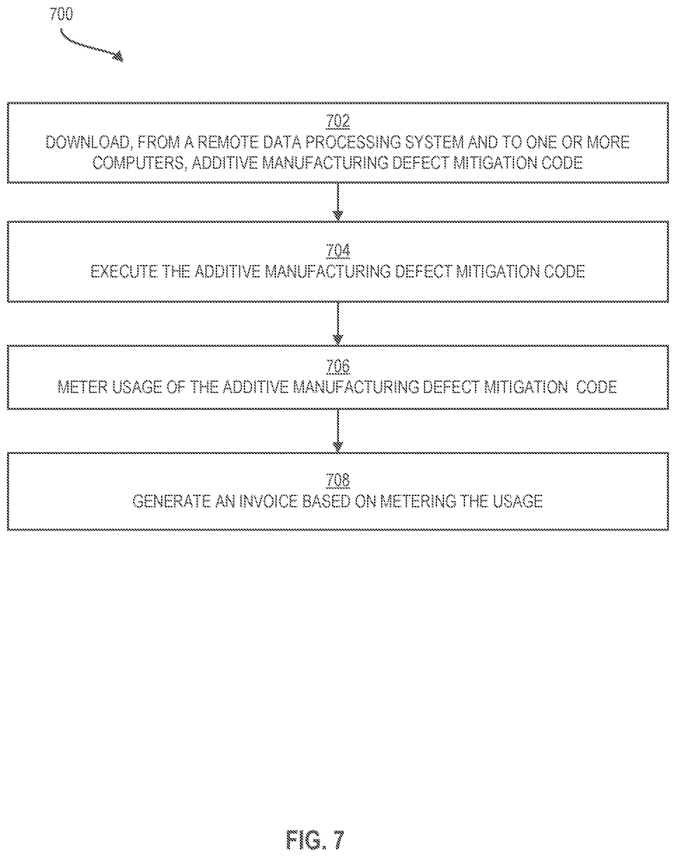

FIG. 7 illustrates a flowchart of an example method 700 for downloading, deploying, metering, and billing usage of additive manufacturing defect mitigation code, in accordance with some embodiments of the present disclosure. The method 700 can be implemented by, for example a print manager of a 3D printer (e.g., print manager 114 of FFF 3D printer 100 as in FIG. 1), a computer implementing code (e.g., computer 801 implementing additive manufacturing defect mitigation code 846 of FIG. 8), a processor, or another configuration of hardware and/or software.

Operation 702 includes downloading, from a remote data processing system and to one or more computers (e.g., FFF 3D printer 100 of FIG. 1, computer 801 of FIG. 8, etc.) additive manufacturing defect mitigation code (e.g., additive manufacturing defect mitigation code 846 of FIG. 8). Operation 704 includes executing the additive manufacturing defect mitigation code. Operation 704 can include performing any of the methods and/or functionalities discussed herein. Operation 706 includes metering usage of the additive manufacturing defect mitigation code. Usage can be metered by, for example, an amount of time the additive manufacturing defect mitigation code is used, a number of servers and/or devices deploying the additive manufacturing defect mitigation code, an amount of resources consumed by implementing the additive manufacturing defect mitigation code, a number of objects printed using the additive manufacturing defect mitigation code, and/or other usage metering metrics. Operation 708 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 illustrates a block diagram of an example computing environment, in accordance with some embodiments of the present disclosure. Computing environment 800 contains an example of an environment for the execution of at least some of the computer code involved in performing the inventive methods, such as additive manufacturing defect mitigation code 846. In addition to additive manufacturing defect mitigation code 846, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and additive manufacturing defect mitigation code 846, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in additive manufacturing defect mitigation code 846 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in additive manufacturing defect mitigation code 846 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is computer-implemented method. The method includes manufacturing an object using a fused filament fabrication (FFF) three-dimensional (3D) printer reading a sliced model file; determining an error for at least one layer in the object during the manufacturing; pausing manufacturing the object using the FFF 3D printer reading the sliced model file; depositing additional material using the FFF 3D printer and based on corrective printing parameters generated to mitigate the error; and resuming manufacturing the object using the FFF 3D printer reading the sliced model file.

Example 2 includes the features of Example 1. In this example, the error is identified by a visual inspection tool after depositing the at least one layer in the object undergoing fabrication.

Example 3 includes the features of Example 1. In this example, the error is predicted by a machine learning model prior to depositing the at least one layer in the object undergoing fabrication. Optionally, the error is predicted by the machine learning model based on a geometry of the object, a material of the object, a nozzle temperature, a nozzle backpressure, a nozzle speed, an ambient temperature, and an ambient humidity.

Example 4 includes the features of any one of Examples 1 to 3, including or excluding optional features. In this example, manufacturing the object utilizes a primary print head of the FFF 3D printer, and wherein depositing the additional material utilizes a secondary print head of the FFF 3D printer.

Example 5 is a computer-implemented method. The method includes manufacturing an object using a primary print head of a fused filament fabrication (FFF) three-dimensional (3D) printer reading a sliced model file; determining an error for at least one layer in the object during the manufacturing; and depositing additional material using a secondary print head of the FFF 3D printer and based on corrective printing parameters generated to mitigate the error.

Example 6 includes the features of Example 5. In this example, the error is identified by a visual inspection tool after depositing the at least one layer in the object undergoing fabrication.

Example 7 includes the features of Example 5. In this example, the error is predicted by a machine learning model prior to depositing the at least one layer in the object undergoing fabrication. Optionally, the error is predicted by the machine learning model based on a geometry of the object, a material of the object, a temperature of a primary nozzle, a backpressure of the primary nozzle, a speed of the primary nozzle, an ambient temperature, and an ambient humidity. Optionally, the machine learning model is trained on a corpus of objects fabricated by fused filament deposition and associated defects.

Example 8 is a computer-implemented method. The method includes manufacturing an object using a fused filament fabrication (FFF) three-dimensional (3D) printer reading a sliced model file; determining an error for at least one layer in the object during the manufacturing; updating the sliced model file to correct the error in one or more subsequent layers in the object; and resuming manufacturing the object using the FFF 3D printer reading the updated sliced model file, wherein the updated sliced model file corrects the error in one or more subsequent layers in the object.

Example 9 includes the features of Example 8. In this example, the error is identified by a visual inspection tool after depositing the at least one layer in the object undergoing fabrication.

Example 10 includes the features of Example 8. In this example, the error is predicted by a machine learning model prior to depositing the at least one layer in the object undergoing fabrication. Optionally, the error is predicted by the machine learning model based on a geometry of the object, a material of the object, a temperature of a primary nozzle, a backpressure of the primary nozzle, a speed of the primary nozzle, an ambient temperature, and an ambient humidity. Optionally, the machine learning model is trained on a corpus of: objects fabricated by fused filament deposition and defects associated with the objects; and wherein the machine learning model is retrained using feedback from: additional objects fabricated by fused filament deposition, their determined errors, and outcomes of their associated corrective printing parameters.

Example 11 is a system. The system includes one or more computer readable storage media storing program instructions; and one or more processors which, in response to executing the program instructions, are configured to perform a method according to any one of Examples 1 to 10, including or excluding optional features.

Example 12 is a computer program product. The computer program product includes one or more computer readable storage media, and program instructions collectively stored on the one or more computer readable storage media, the program instructions comprising instructions configured to cause one or more processors to perform a method according to any one of Examples 1 to 10, including or excluding optional features.

Example 13 is a system. The system includes one or more computer-readable storage media storing: a sliced model file of an object to be manufactured; and a machine learning model configured to predict an error in the sliced model file and generate corrective printing parameters; and a Fused Filament Fabrication (FFF) three-dimensional (3D) printer communicatively coupled to the one or more computer-readable storage media, wherein the FFF 3D printer is configured to print the object according to the sliced model file and the corrective printing parameters.

Example 14 includes the features of Example 13. In this example, the FFF 3D printer comprises a primary print head and a secondary print head, and wherein the primary print head is configured to print the object according to the sliced model file, and wherein the secondary print head is configured to print the corrective printing parameters.

Example 15 includes the features of any one of Examples 13 to 14. In this example, the error is predicted by the machine learning model based on a geometry of the object, a material of the object, a temperature of a nozzle, a backpressure of a nozzle, a speed of a nozzle, an ambient temperature, and an ambient humidity.

Example 16 includes the features of any one of Examples 13 to 15. In this example, the machine learning model is trained on a corpus of objects fabricated by fused filament deposition, and defects associated with the objects. Optionally, the machine learning model is retrained using feedback from: additional objects fabricated by fused filament deposition, their determined errors, and outcomes of their associated corrective printing parameters.

Example 17 is a system. The system includes one or more computer-readable storage media storing: a sliced model file of an object to be manufactured; and a machine learning model configured to detect an error from observed dimensional data during manufacture of the object and generate corrective printing parameters to remedy the error; a visual inspection tool communicatively coupled to the one or more computer-readable storage media configured to generate the observed dimensional data of the object during the manufacture; and a Fused Filament Fabrication (FFF) three-dimensional (3D) printer communicatively coupled to the one or more computer-readable storage media, wherein the FFF 3D printer is configured to print the object according to the sliced model file and the corrective printing parameters.

Example 18 includes the features of Example 17. In this example, the FFF 3D printer comprises a primary print head and a secondary print head, and wherein the primary print head is configured to print the object according to the sliced model file, and wherein the secondary print head is configured to print the corrective printing parameters.

Example 19 includes the features of any one of Examples 17 to 18. In this example, the error is predicted by the machine learning model based on a geometry of the object, a material of the object, a temperature of a nozzle, a backpressure of a nozzle, a speed of a nozzle, an ambient temperature, and an ambient humidity.

Example 20 includes the features of any one of Examples 17 to 19. In this example, the machine learning model is trained on a corpus of objects fabricated by fused filament deposition, and defects associated with the objects. Optionally, the machine learning model is retrained using feedback from: additional objects fabricated by fused filament deposition, their determined errors, and outcomes of their associated corrective printing parameters.

What is claimed is:

1. A computer-implemented method comprising:
manufacturing an object using a fused filament fabrication (FFF) three-dimensional (3D) printer reading a sliced model file;
determining an error for at least one layer in the object during the manufacturing;
pausing manufacturing the object using the FFF 3D printer reading the sliced model file;
depositing additional material using the FFF 3D printer and based on corrective printing parameters generated to mitigate the error; and
resuming manufacturing the object using the FFF 3D printer reading the sliced model file.

2. The computer-implemented method of claim 1, wherein the error is identified by a visual inspection tool after depositing the at least one layer in the object undergoing fabrication.

3. The computer-implemented method of claim 1, wherein the error is predicted by a machine learning model prior to depositing the at least one layer in the object undergoing fabrication.

4. The computer-implemented method of claim 3, wherein the error is predicted by the machine learning model based on a geometry of the object, a material of the object, a nozzle temperature, a nozzle backpressure, a nozzle speed, an ambient temperature, and an ambient humidity.

5. The method of claim 1, wherein manufacturing the object utilizes a primary print head of the FFF 3D printer, and wherein depositing the additional material utilizes a secondary print head of the FFF 3D printer.

6. A computer-implemented method comprising:
manufacturing an object using a primary print head of a fused filament fabrication (FFF) three-dimensional (3D) printer reading a sliced model file;
determining an error for at least one layer in the object during the manufacturing; and
depositing additional material using a secondary print head of the FFF 3D printer and based on corrective printing parameters generated to mitigate the error.

7. The computer-implemented method of claim 6, wherein the error is identified by a visual inspection tool after depositing the at least one layer in the object undergoing fabrication.

8. The computer-implemented method of claim 6, wherein the error is predicted by a machine learning model prior to depositing the at least one layer in the object undergoing fabrication.

9. The computer-implemented method of claim 8, wherein the error is predicted by the machine learning model based on a geometry of the object, a material of the object, a temperature of a primary nozzle, a backpressure of the primary nozzle, a speed of the primary nozzle, an ambient temperature, and an ambient humidity.

10. The computer-implemented method of claim 8, wherein the machine learning model is trained on a corpus of objects fabricated by fused filament deposition and associated defects.

11. A computer-implemented method comprising:
manufacturing an object using a fused filament fabrication (FFF) three-dimensional (3D) printer reading a sliced model file;
determining an error for at least one layer in the object during the manufacturing;
updating the sliced model file to correct the error in one or more subsequent layers in the object; and
resuming manufacturing the object using the FFF 3D printer reading the updated sliced model file, wherein the updated sliced model file corrects the error in one or more subsequent layers in the object.

12. The computer-implemented method of claim 11, wherein the error is identified by a visual inspection tool after depositing the at least one layer in the object undergoing fabrication.

13. The computer-implemented method of claim 11, wherein the error is predicted by a machine learning model prior to depositing the at least one layer in the object undergoing fabrication.

14. The computer-implemented method of claim 13, wherein the error is predicted by the machine learning model based on a geometry of the object, a material of the object, a temperature of a primary nozzle, a backpressure of the primary nozzle, a speed of the primary nozzle, an ambient temperature, and an ambient humidity.

15. The computer-implemented method of claim 13, wherein the machine learning model is trained on a corpus of:
objects fabricated by fused filament deposition and defects associated with the objects; and
wherein the machine learning model is retrained using feedback from:
additional objects fabricated by fused filament deposition, their determined errors, and outcomes of their associated corrective printing parameters.

16. A system comprising:
one or more computer-readable storage media storing:
a sliced model file of an object to be manufactured; and
a machine learning model configured to predict an error in the sliced model file and generate corrective printing parameters; and
a Fused Filament Fabrication (FFF) three-dimensional (3D) printer communicatively coupled to the one or more computer-readable storage media, wherein the FFF 3D printer is configured to print the object according to the sliced model file and the corrective printing parameters.

17. The system of claim 16, wherein the FFF 3D printer comprises a primary print head and a secondary print head, and wherein the primary print head is configured to print the object according to the sliced model file, and wherein the secondary print head is configured to print the corrective printing parameters.

18. The system of claim 16, wherein the error is predicted by the machine learning model based on a geometry of the object, a material of the object, a temperature of a nozzle, a backpressure of a nozzle, a speed of a nozzle, an ambient temperature, and an ambient humidity.

19. The system of claim 16, wherein the machine learning model is trained on a corpus of objects fabricated by fused filament deposition, and defects associated with the objects.

20. The system of claim 19, wherein the machine learning model is retrained using feedback from:
additional objects fabricated by fused filament deposition, their determined errors, and outcomes of their associated corrective printing parameters.

21. A system comprising:
one or more computer-readable storage media storing:
a sliced model file of an object to be manufactured; and
a machine learning model configured to detect an error from observed dimensional data during manufacture of the object and generate corrective printing parameters to remedy the error;
a visual inspection tool communicatively coupled to the one or more computer-readable storage media configured to generate the observed dimensional data of the object during the manufacture; and
a Fused Filament Fabrication (FFF) three-dimensional (3D) printer communicatively coupled to the one or more computer-readable storage media, wherein the FFF 3D printer is configured to print the object according to the sliced model file and the corrective printing parameters.

22. The system of claim 21, wherein the FFF 3D printer comprises a primary print head and a secondary print head, and wherein the primary print head is configured to print the object according to the sliced model file, and wherein the secondary print head is configured to print the corrective printing parameters.

23. The system of claim 21, wherein the error is predicted by the machine learning model based on a geometry of the object, a material of the object, a temperature of a nozzle, a backpressure of a nozzle, a speed of a nozzle, an ambient temperature, and an ambient humidity.

24. The system of claim 21, wherein the machine learning model is trained on a corpus of objects fabricated by fused filament deposition, and defects associated with the objects.

25. The system of claim 24, wherein the machine learning model is retrained using feedback from:
additional objects fabricated by fused filament deposition, their determined errors, and outcomes of their associated corrective printing parameters.
